(19) United States
(12) Patent Application Publication
(10) Pub. No.: US 2010/0047577 A1
(43) Pub. Date: Feb. 25, 2010

(54) Converting Brominated Anionic Styrenic Polymer Into Harder and Larger Form for Storage, Shipment, and Use

(75) Inventors: Douglas W. Luther, Walker, LA (US); John F. Balhoff, Baton Rouge, LA (US); Robert C. Herndon, JR., Baton Rouge, LA (US); Bruce C. Peters, Baton Rouge, LA (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 12/515,420

(22) PCT Filed: Jul. 18, 2007
(86) PCT No.: PCT/US07/73804

§ 371 Date: May 19, 2009

Related U.S. Application Data
(60) Provisional application No. 60/867,548, filed on Nov. 28, 2006.

(51) Int. Cl. B32B 5/16; B29B 9/00

(52) U.S. Cl. 428/402; 264/14

(57) ABSTRACT

Granules/pastilles of unadulterated brominated anionic styrenic polymer are prepared and provided. They are made by forming a downward plug flow from an orifice in a manifold or nozzle in proximity to a cooled traveling planar member. Such member is impervious to cooling liquid. There is a gap between the lower end of the orifice and the planar member. A portion of a plug of the molten polymer either (i) bridges such gap or (ii) freely drops from the orifice and falls upon the planar member, in either case forming an individual granule/pastille on the planar member and solidifies thereon. The traveling member is cooled by a mist or spray of cooling liquid applied to the underside of the planar member. The granules/pastilles have superior properties.

### TECHNICAL FIELD

This invention relates to a new form of unadulterated brominated anionic styrenic polymers such as unadulterated brominated anionic polystyrene. This invention also relates to processes for producing such new forms of unadulterated brominated anionic styrenic polymers such as unadulterated brominated anionic polystyrene. These new forms can be called pastilles, pastils, or granules. Whatever the name used, the new forms are characterized by larger size than those presently available in the marketplace. In addition, these new forms have great resistance to crushing, in other words they have high crush strength. Moreover, as produced they are essentially free of dust.

### BACKGROUND

As pointed out in commonly-owned WIPO Pub. No. WO 2005/118245 A1 published 15 Dec. 2005, a characteristic of brominated anionic styrenic polymers such as brominated anionic polystyrene is its propensity to form substantial amounts of small particles and powders when attempts are made to pelletize the product. It appears that upon formation the pellets or granules, unless the fine particles thereof are bound together by an extraneous binding agent or the like, tend to break apart and to revert to small particles and finely-divided powder, typically referred to as “fines”. Because of this characteristic, various conventional pelletizing procedures are unsuitable for producing brominated anionic styrenic polymers essentially free of fines. As can be readily appreciated, the existence of fines in a product of this type this is not only detrimental to the appearance of the product but in addition is undesired by the consumer.

A process enabling production of unadulterated pelletized brominated anionic styrenic polymer essentially free of fines is described in WIPO Pub. No. WO 2005/118245. That process comprises A) forming strands of molten unadulterated brominated anionic styrenic polymer;

B) submitting such strands to cooling and downwardly directed forced air flow on a porous conveyor belt whereby said strands are broken into pellets; and

C) causing such pellets to drop into a classifier that removes fines from the pellets.

In conducting that process the conveyor belt system is typically provided with vacuum equipment beneath the porous belt which continuously draws air down onto the strands on the belt and downwardly through the apertures in the belt itself. Above the conveyor belt are disposed a water spray mechanism for cooling the hot polymer strands and downwardly disposed air blowers which apply sufficient force to the cooling strands which typically causes at least some breakage of the strands to occur on the belt. Surviving unbroken strands, if any, typically undergo at least some breakage as they leave the conveyor belt because of the force of gravity acting upon the unsupported strands emerging from the end of the belt.

While an effective process suitable for commercial operation, several shortcomings of that process exist. For one thing large amounts of water are needed in order to cool the hot strands on the conveyor belt. This in turn makes it desirable, if not necessary, to dry the pellets before they are packaged and this adds substantially to the equipment and operating costs involved in the operation. In addition, the processing used tends to result in the formation of pellets that on the average are smaller than desired. And further, it would be advantageous if an unadulterated brominated anionic styrenic polymer product could be formed having an even greater crush strength and being free or essentially free of dust.

### BRIEF SUMMARY OF THE INVENTION

Process technology has now been found which enables production of a new form of essentially dust-free granules of unadulterated brominated anionic styrenic polymer having desirable properties without contacting the granules or pastilles with water or other liquid during their preparation, thus avoiding the need for drying the granules prior to packaging. As compared to the best pellets which could be prepared pursuant to the state of the art prior to this invention, it is now possible to produce and provide a new form of granules of unadulterated brominated anionic styrenic polymer having larger average particle sizes and having increased crush strength. These new granules have a generally solid hemispherical shape, i.e., they are solids having the shape of a dome with a generally flat, circular planar lowermost surface. Because of this configuration, there are few, if any, surface irregularities or projections that would tend to break off and form small pieces, dust, or the like.

This invention also provides in one of its embodiments, a new process for preparing new granules or pastilles of unadulterated brominated anionic styrenic polymer devoid of most, if not all, of the shortcomings of the commercially-available pellets. This process comprises forming a downwardly oriented plug flow from at least one orifice in a nozzle or member that is in proximity to a cooled traveling planar member, said planar member being impervious to cooling liquid and having an upper and lower surface, whereby there is a gap between the lower portion of the orifice and said upper surface, so that at least a portion of a plug of molten unadulterated brominated anionic styrenic polymer either (i) bridges said gap and forms a separate individual granule or pastille on the upper surface of said planar member, or (ii) freely drops from the lower portion of the orifice and falls upon the upper surface of said planar member and forms an individual granule or pastille on the upper surface of said traveling planar member, said traveling planar member being cooled by a mist or spray of cooling liquid contacting the lower surface of said planar member. The preferred cooling liquid is cooling water applied by spray nozzles to the underside of the upper portion of the traveling belt.

Another embodiment of this invention is generally hemispherically-shaped solid granules or pastilles of unadulterated brominated anionic styrenic polymer (preferably hemispherically-shaped solid granules or pastilles of unadulterated brominated polystyrene) which have (i) a bromine content of at least about 50 wt % (i.e., about 50 wt % or more), (ii) an average particle length of at least 0.2 inch, and an average crush strength of at least 40 pounds per inch, and preferably, at least 45 pounds per inch using the test procedure described in Example 2 hereinafter.

The above and other embodiments and features of this invention will become still further apparent from the ensuing description and appended claims.

### FURTHER DETAILED DESCRIPTION OF EMBODIMENTS OF THE INVENTION

Pursuant to one embodiment of this invention there is provided a process of preparing generally hemispherically-shaped granules or pastilles of unadulterated brominated anionic styrenic polymer. The process of this embodiment involves flowing or injecting molten unadulterated brominated anionic styrenic polymer downwardly into at least one small downwardly disposed orifice in a manifold or nozzle (preferably through a plurality of laterally disposed small downwardly disposed orifices in a manifold or nozzle) so that droplets of the molten polymer emerge and extend from the underside of the manifold or nozzle. These droplets either (i) individually fall or are caused to individually fall from the manifold or nozzle onto the cooled upper surface of a cooled traveling planar member thereby forming generally hemispherically-shaped granules or pastilles of the unadulterated brominated anionic styrenic polymer which solidify in that general shape, or (ii) traverse a small gap between the manifold or nozzle and the cooled upper surface of the cooled traveling planar member and thereupon separate from such manifold or nozzle into generally hemispherically-shaped granules or pastilles on such cooled upper surface and solidify in that general shape.

It will be seen that in (i) above the droplets of molten unadulterated brominated anionic styrenic polymer undergo free fall from the bottom of the manifold or nozzle onto the cooled traveling planar surface and form into a generally hemispherically-shaped solid. In the case of (ii) above, the droplets span the bridge between the bottom of the manifold or nozzle and the cooled traveling planar surface and then, because of the travel, become separated from the manifold or nozzle and thus form into a generally hemispherically-shaped solid. The period of travel on the planar member should be long enough for the generally hemispherically-shaped solids of this invention to solidify while remaining on the surface of the planar member.

The traveling planar member is impervious to liquid cooling fluid and is cooled by application of a mist or spray of liquid cooling fluid, preferably chilled water, directed generally upwardly from nozzles onto the underside of the planar member thus cooling the granules or pastilles by conduction of heat from them. The planar member can be in the form of a sheet of a liquid-impermeable, heat conductive substance, which sheet is caused to travel in a generally horizontal plane, e.g., back and forth in alternating opposite linear directions, in a continuous circular path, or in other similar ways. Preferably, the planar member is an endless belt of a liquid-impermeable, heat conductive substance, preferably a metal or metal alloy. An endless belt in the form of a water-impermeable flexible steel belt traveling on rollers in the manner of a conveyor belt serves as an example of a suitable heat conductive, liquid-impermeable endless belt.

### Brominated Anionic Styrenic Polymer

The polymers which are converted into the new, generally hemispherically-shaped form pursuant to this invention, are one, or a blend of more than one, unadulterated brominated anionic styrenic polymer, i. e., (i) at least one anionically-produced styrenic homopolymer that has been brominated or (ii) at least one anionically-produced copolymer of two or more styrenic monomers that has been brominated, or (iii) both of (i) and (ii). The bromine content of such polymer should be at least about 50 percent by weight. Preferred brominated anionic styrenic polymers, especially brominated anionic polystyrene, have a bromine content of at least about 60 wt %, and more preferred brominated anionic styrenic polymers, especially brominated anionic polystyrene, have a bromine content of at least about 64 wt %. More preferred brominated anionic styrenic polymers, especially brominated anionic polystyrenes, have a bromine content of at least about 67 wt %. The bromine content of brominated anionic styrenic polymers such as brominated anionic polystyrene will seldom exceed about 71-72 wt %. A particularly preferred range of bromine concentrations is about 67 to about 71.

In all embodiments of this invention the most preferred brominated anionic styrenic polymer used in forming the granules or pastilles of this invention is unadulterated brominated anionic polystyrene.

By the term “unadulterated” is meant that no extraneous ingredients such as binders (e.g., waxes or other polymeric or oligomeric substances), inorganic salts, or the like are added to the brominated anionic styrenic polymer prior to or during the foregoing method of preparing the granules or pastilles. Instead, the brominated anionic styrenic polymer contains only residual impurities that remain in the brominated polymer after its preparation.

As is well known to those skilled in the art, anionic styrenic polymers differ structurally from styrenic polymers formed by use of free radical catalysts or cationic catalysts in that the anionic styrenic polymers are formed as “living polymers” and thus have molecular end groups which differ from those formed from the other polymerization processes.

Anionic styrenic polymers which are brominated to form the brominated anionic styrenic polymers which are used in producing the new granules or pastilles pursuant to this invention are one or more anionic homopolymers and/or anionic copolymers of at least one vinyl aromatic monomer. Preferred vinyl aromatic monomers have the formula:

H₂C═CR—Ar

wherein R is a hydrogen atom or an alkyl group having from 1 to 4 carbon atoms and Ar is an aromatic group (including alkyl-ring substituted aromatic groups) of from 6 to 10 carbon atoms. Examples of such monomers are styrene, alpha-methylstyrene, ortho-methylstyrene, meta-methylstyrene, para-methylstyrene, para-ethylstyrene, isopropenyltoluene, vinylnaphthalene, isopropenylnaphthalene, vinylbiphenyl, vinylanthracene, the dimethylstyrenes, and tert-butylstyrene. Polystyrene is the preferred reactant. When the brominated anionic styrenic polymer is made by bromination of an anionic copolymer of two or more vinyl aromatic monomers, it is preferred that styrene be one of the monomers and that styrene comprise at least 50 weight percent and preferably at least about 80 weight percent of the copolymerizable vinyl aromatic monomers. It is to be noted that the terms “brominated anionic styrenic polymer” and “brominated anionic polystyrene” as used herein refer to a brominated anionic polymer produced by bromination of a pre-existing anionic styrenic polymer such as anionic polystyrene or an anionic copolymer of styrene and at least one other vinyl aromatic monomer, as distinguished from an oligomer or polymer produced by oligomerization or polymerization of one or more brominated styrenic monomers, the properties of the latter oligomers or polymers being considerably different from brominated anionic polystyrene in a number of respects. Also, the terms “vinylaromatic” and “styrenic” in connection with monomer(s) polymer(s) used interchangeably herein.

The aromatic pendant constituents of the anionic styrenic polymer can be alkyl substituted or substituted by bromine or chlorine atoms, but in most cases, will not be so substituted. Typically, the anionic styrenic polymers used to produce the brominated anionic styrenic polymers used in the practice of this invention will have a weight average molecular weight (Mw) in the range of about 2000 to about 50,000 and a polydispersity in the range of 1 to about 10. Preferred brominated anionic styrenic polymers used in the practice of this invention are produced from anionic styrenic polymers having a weight average molecular weight (Mw) in the range of about 3000 to about 10,000 and a polydispersity in the range of 1 to about 4, and most preferably these ranges are, respectively, about 3500 to about 4500 and 1 to about 4.

The M_{w} and polydispersity values are both based on gel permeation chromatography (GPC) techniques which are hereinafter described.

Methods for the preparation of anionic styrenic polymers such as anionic polystyrene are known in the art and reported in the literature. See for example, U.S. Pat. Nos. 3,812,088; 4,200,713; 4,442,273; 4,883,846; 5,391,655; 5,717,040; and 5,902,865, the disclosures of which are incorporated herein by reference. An especially preferred method is described in commonly-owned U.S. Pat. No. 6,657,028, issued Dec. 2, 2003, the disclosure of which method is incorporated herein by reference.

Bromination processes which can be used for producing a brominated anionic styrenic polymer are disclosed in U.S. Pat. Nos. 5,677,390; 5,686,538; 5,767,203; 5,852,131; 5,916,978; and 6,207,765 which disclosures are incorporated herein by reference.

Typical properties of preferred brominated anionic polystyrene for use in preparing the granules or pastilles of this invention include the following:
Appearance/form—white powder
Bromine Content—67 to 71 wt %
Melt flow index (220° C. 2.16 kg)—4 to 35 g/10 min
Tg (° C.)—162
Specific gravity(at 23° C.)—2.2
TGA (TA instruments model 2950, 10° C./min. under nitrogen):
   1% weight loss, ° C.—342
   5% weight loss, ° C.—360
   10% weight loss, ° C.—368

50% weight loss, ° C.—393

90% weight loss, ° C.—423

Instead of using powdered brominated anionic styrenic polymer such as brominated anionic polystyrene as the starting material, advantages can be gained by utilizing brominated anionic styrenic polymer solutions as produced in a styrenic polymer bromination plant facility. Such solutions are subjected to procedures that remove the solvent at an elevated temperature leaving a melt of brominated anionic styrenic polymer such as a melt of brominated anionic polystyrene. Such melt can be directly used as feed to the equipment used in forming the granules or pastilles of this invention.

If deemed necessary or desirable, any reliable analytical procedure such as reported in the literature can be employed in determining such analysis or properties. In any doubtful or disputed case, the following procedures are recommended:

1) Bromine Content—Since brominated anionic styrenic polymers have good, or at least satisfactory, solubility in solvents such as tetrahydrofuran (THF), the determination of the total bromine content for a brominated anionic styrenic polymer is easily accomplished by using conventional X-Ray Fluorescence techniques. The sample analyzed is a dilute sample, say, 0.1±0.05 g brominated anionic polystyrene in 60 mL THF. The XRF spectrometer can be a Phillips PW1480 Spectrometer. A standardized solution of bromobenzene in THF is used as the calibration standard.

2) Weight Average Molecular Weight and Polydispersity—M_{w} values of anionic styrenic polymers are obtained by GPC using a Waters model 510 HPLC pump and, as detectors, a Waters Refractive Index Detector, Model 410 and a Precision Detector Light Scattering Detector, Model PD2000, or equivalent equipment. The columns are Waters, Styragel, 500A, 10,000 and 100,000 A. The autosampler is a Shimadzu, Model Sil 9A. A polystyrene standard(M_{w}=185,000) is routinely used to verify the accuracy of the light scattering data. The solvent used is tetrahydrofuran, HPLC grade. The test procedure used entails dissolving 0.015-0.020 g of sample in 10 mL of THF. An aliquot of this solution is filtered and 50 L is injected on the columns. The separation is analyzed using software provided by Precision Detectors for the PD 2000 Light Scattering Detector. The instrument provides results in terms of weight average molecular weight and also in terms of number average molecular weight. Thus, to obtain a value for polydispersity, the value for weight average molecular weight is divided by the value for number average molecular weight.

### Production of Granules or Pastilles

In other embodiments of this invention, the granules or pastilles of this invention are produced by a process which comprises:

A) providing molten unadulterated brominated styrenic polymer in, or injecting molten unadulterated brominated styrenic polymer into, at least one small downwardly disposed orifice in a manifold or in a nozzle, and preferably through a plurality of laterally disposed small downwardly disposed orifices in a manifold or plurality of nozzles, so that droplets of the molten polymer emerge and extend from the underside of the manifold or nozzles; and

B1) having the droplets initially come into contact with a cooled traveling endless steel conveyor belt impervious to cooling liquids while the droplets are in contact with the manifold or nozzle and then the droplets separate from the molten unadulterated brominated anionic styrenic polymer as separate granules or pastilles on a cooled traveling endless steel conveyor belt impervious to cooling liquids, wherein the upper portion of the belt is traveling transversely to the downward travel of the droplets, and wherein a cooling medium is continuously applied to the underside of the upper portion of the belt so that successive portions of the upper portion of the traveling belt reaching the zones in which (i) the droplets come into contact with the belt and (ii) separate granules or pastilles formed on the belt are at least beginning to partially solidify, are cooled by conduction of heat by such application of cooling medium to the underside of the upper portion of the belt; or

B2) having the droplets separate and fall from the manifold or nozzle onto, and solidify as separate granules or pastilles on, a cooled traveling endless steel conveyor belt impervious to cooling liquids, wherein the upper portion of the belt is traveling transversely to the downward fall of the separated droplets, and wherein a cooling medium is continuously applied to the underside of the upper portion of the belt so that successive portions of the upper portion of the traveling belt reaching the zones in which (i) the separated droplets come into contact with the belt and (ii) separate granules or pastilles formed on the belt are at least beginning to partially solidify, are cooled by conduction of heat by such application of cooling medium to the underside of the upper portion of the belt.

In one such embodiment the process is conducted using A) and B1). In other words, in such embodiment B2) is not used. In another such embodiment, the process is conducted using A) and B2) which means, in other words, that B1) is not used in this case. It is possible to carry out the process whereby besides using A), both B1) and B2) occur in an alternating or random manner.

A feature of this invention is that equipment is already available in the marketplace that can be used in practicing the above process. For example, Kaiser Steel Belt Systems GmbH can provide equipment suitable for use with brominated anionic styrenic polymers of various molecular weight ranges. Because of the technology used in such equipment, the granules produced by such equipment are typically referred to as pastilles or pastils. However, for the purposes of this invention, the particles of this invention are designated as granules or pastilles since, as noted above, they have more or less generally well-defined shapes.

The pastillation equipment produced by Kaiser Steel Belt Systems is presently available in several different operating systems. In pastillation system ZN, a vertically disposed eccentrically driven needle operating in a vertically disposed nozzle interrupts the downward flow of melt from melt jets forming at the nozzle orifices. The interrupted flow is proximate to the upper surface of a traveling endless heat-conductive belt and tends to span the gap from the lowermost tip of the nozzle orifice to the upper surface of the belt. Such movement of the belt results in separation of the melt from the orifice thereby forming an individual granule or pastille which is carried on the belt. Water jets below the portion of the belt carrying the granules or pastilles direct a spray of water that cools the belt and via indirect heat conduction, the granules or pastilles disposed thereon. This system is designed for use with melts having relatively low viscosity ranges, e.g., brominated anionic polystyrenes of lower viscosities than are currently available in the marketplace. In Pastillation System GS, the same principle is used as in the ZN System, except that a cylinder and eccentrically driven piston are used to force the portions of the melt downwardly onto the traveling heat conductive belt. This system is designed for use with somewhat more viscous materials. However, here again, the viscosities of brominated anionic polystyrenes currently available in the marketplace are higher than can be readily used in system GS. A third system offered by Kaiser Steel Belt Systems is Pastillation System Rollomat® which is well-suited for use in the practice of this invention with present commercially-available brominated anionic styrenic polymer. This third system is a rotating system comparable to a gear pump and once again the melt issues downwardly, in this case under increased force, from a rotating system onto the underlying traveling belt. In each system, the melt is indicated by the manufacturer to traverse the space between the lower tip of the nozzle and the upper surface of the traveling belt prior to breakage of that connection and resultant formation of an independent granule or pastille traveling on the belt. For further details concerning such equipment, reference should be had to a two-page brochure entitled “KAISER Steel Belt Systems—From Melt to Solid”, currently available from Kaiser SBS GMBH, Magdeburger Str. 17, D-47800 Krefeld, Germany, e-mail: info@KAISER-SBS.de; www.KAISER-SBS.de. In addition, aspects of the third system appear to be disclosed in U.S. Pat. Nos. 5,198,233 and 5,378,132.

Another aspect of this invention is the discovery that the process technology of this invention and the same apparatus used in the practice of this invention can be utilized in preparing granules or pastilles formed from mixtures of components comprised of brominated a major amount (more than 50 wt %) of anionic styrenic polymer and a minor amount (less than 50 wt %) of a different thermoplastic polymer such as polybutylene terephthalate. Heretofore, different processes and apparatus had to be used to pelletize unadulterated brominated anionic polystyrene on the one hand and to pelletize blends of unadulterated brominated anionic polystyrene and another thermoplastic polymer such as polybutylene terephthalate on the other. However, when using a process as described herein, blends of (I) brominated anionic styrenic polymer such as brominated anionic polystyrene, and (II) at least one thermoplastic polymer that is compatible with the brominated anionic polystyrene can be processed in substantially the same way as the same brominated anionic styrenic polymer by itself. Consequently, the processes of this invention can be applied to forming blends containing >50 wt % of (I) and <50 wt % of (II), preferably at least 70 wt % of (I) and 30 wt % or less of (II) and more preferably at least 80 wt % of (I) and 20 wt % or less of (II). Typically, at least 90 wt %, and preferably at least 95 wt %, of the blend proportioned as just described is made up of (I) and (II), the balance, if any, being one or more additives commonly used in flame retarded thermoplastic polymers, such as thermal stabilizers, antioxidants, processing aids, flame retardant synergists, lubricants, mold release agents, and similar functional additives.

Non-limiting examples of thermoplastic polymers which can be utilized in admixture with brominated anionic styrenic polymer of comparable viscosity in forming granules or pastilles include such thermoplastic polymers as non-halogenated styrenic polymers, polyolefins, functionally-substituted polyolefinic polymers, polyesters, polyamides, polycarbonates, polysulfones, polyphenylene oxides, and blends or alloys of thermoplastic polymers such as polycarbonate-ABS, polybutylene terephthalate-ABS, and polyphenylene oxide-polystyrene blends.

The operating conditions used in carrying out the processes of this invention are as follows:

a) The processing temperature used is a temperature at which the brominated anionic styrenic polymer is in a molten condition, but not so high as to cause thermal decomposition of such polymer. With brominated anionic polystyrenes with weight average molecular weights in the range of about 3000 to about 40,000, temperatures of the molten polymer in the range of about 150° to about 320° C. are typical.

b) The speed of the traveling planar member, (e.g., an endless steel belt) is matched with the rate at which separate individual pastilles are formed on the traveling belt.

c) When using presently available commercial equipment such as one of the systems available from Kaiser Steel Belt Systems, the system should be chosen so as to be suitable for use with the melt viscosity of the brominated anionic polymer being pastillated.

d) The cooling water or other cooling liquid applied to the under surface of the traveling planar member should be low enough as to provide sufficient cooling to the traveling granules or pastilles such that they are fully solidified prior to being removed from the planar member. Temperatures in the range of about 4 to about 50° C. are typical.

The following examples are presented for purposes of illustration. They are not intended to limit the invention to only the subject matter disclosed therein.

### EXAMPLE 1

Using a Rollormat® pastillation system, (Kaiser Steel Belt Systems) brominated anionic polystyrene having a bromine content of approximately 68% and a melt flow index at 220° C. and 2.16 kilogram load of 4 to 35 grams per 10 minutes was subjected to pastillation. Substantially uniform pastilles were formed and solidified on the water-cooled traveling steel belt. A sample of these pastilles was collected for determination of physical properties.

### EXAMPLE 2

Tests were conducted to measure both the height of 13 randomly selected pastilles produced in the process described in Example 1 and the crush strength of the selected pastilles. The apparatus used in these tests was a Sintech 1/S instrument. The procedure used involved the following:

1) randomly selecting 13 pastilles from the sample undergoing the test and measuring the height of each pastille from its flat base to the peak of its dome;

2) placing a pastille on the stationary unpadded steel plate of the instrument such that the flat surface of the pastille rests on the steel plate with the peak of the dome of the pastille directly below the moveable crosshead of the instrument upon which a 50 pound load cell is attached. Attached to the load cell is a cylindrical shaft which is flat on its lower end that will come in direct contact with the peak of the dome of the pastille;

3) lowering the crosshead to within 0.002 inch of the peak of the dome;

4) lowering the crosshead by the motorized screw drive of the instrument at the rate of 0.2 inch per minute until the pastille is crushed at which point the maximum load is recorded, and the crush strength in pounds per inch is calculated.

The above procedure is repeated individually with each of the 13 randomly selected pastilles from the sample of pastilles undergoing the test. The crush strength is determined in each of the respective 13 cases by dividing the maximum load (in pounds) by the height (in the fraction of an inch) of the respective pastille subjected to the test.

Table 1 summarizes the results of the 13 individual tests, the average values achieved, the standard deviations of the values achieved, and the minimum and maximum values achieved in the test. In Table 1, the granules or pastilles are referred to simply as pastilles for economy of space. The abbreviations used and their full meaning are as follows: in. stands for inch; lbs stands for pounds force; Avg. stands for average; Std. Dev. stands for standard deviation; Min. stands for minimum; and Max. stands for maximum.

TABLE 1

| Pastille | | Peak Load | Energy to Crush, |
|---|---|---|---|
| No. | Pastille Height, inches | Applied, pounds | lbs/in. |
| 1 | 0.207 | 12.97 | 62.66 |
| 2 | 0.213 | 7.56 | 35.49 |
| 3 | 0.219 | 14.52 | 66.30 |
| 4 | 0.208 | 10.23 | 49.18 |
| 5 | 0.213 | 9.26 | 43.47 |
| 6 | 0.199 | 8.00 | 40.20 |
| 7 | 0.224 | 7.34 | 32.77 |
| 8 | 0.207 | 14.67 | 70.87 |
| 9 | 0.200 | 10.08 | 50.40 |
| 10 | 0.214 | 10.23 | 47.80 |
| 11 | 0.204 | 10.00 | 49.02 |
| 12 | 0.219 | 7.85 | 35.84 |
| 13 | 0.220 | 7.19 | 32.68 |
| Average | 0.211 | 9.99 | 47.44 |
| Std. Dev. | 0.008 | 2.60 | 12.68 |
| Min. | 0.199 | 7.19 | 32.7 |
| Max. | 0.224 | 14.67 | 70.9 |

### COMPARATIVE EXAMPLE A

For comparative purposes, 13 randomly selected commercially-available pellets of the same commercially-available brominated anionic polystyrene were subjected to the same test procedure as in Example 2, except that the pellets were not of dome shapes, and thus were placed on the instrument with the pellet arranged with its longest dimension in a horizontal position. These pellets were produced by processing described in WO2005/118245, published 15, Dec. 2005. The results are summarized in Table 2.

TABLE 2

| | | Peak Load | Energy to Crush, |
|---|---|---|---|
| Pellet No. | Pellet Length, inches | Applied, pounds | lbs/in. |
| 1 | 0.126 | 6.00 | 47.62 |
| 2 | 0.133 | 6.45 | 48.50 |
| 3 | 0.131 | 3.56 | 27.18 |
| 4 | 0.162 | 4.22 | 26.05 |
| 5 | 0.170 | 3.26 | 19.18 |
| 6 | 0.140 | 3.70 | 26.43 |
| 7 | 0.162 | 8.74 | 53.95 |
| 8 | 0.162 | 7.34 | 45.31 |
| 9 | 0.168 | 4.37 | 26.01 |
| 10 | 0.183 | 5.33 | 29.13 |
| 11 | 0.195 | 5.41 | 27.74 |
| 12 | 0.185 | 5.48 | 29.62 |
| 13 | 0.274 | 16.23 | 59.23 |
| Average | 0.169 | 6.16 | 35.84 |
| Std. Dev. | 0.038 | 3.41 | 13.06 |
| Min. | 0.126 | 3.26 | 19.2 |
| Max. | 0.274 | 16.23 | 59.2 |

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

Each and every patent or publication referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

1. A process of preparing granules or pastilles of unadulterated brominated anionic styrenic polymer, which process comprises forming a downwardly oriented plug flow from at least one orifice in a manifold or nozzle that is in proximity to a cooled traveling planar member, said planar member being impervious to cooling liquid and having an upper and lower surface, whereby there is a gap between the lower portion of the orifice and said upper surface, so that at least a portion of a plug of molten unadulterated brominated anionic styrenic polymer either (i) bridges said gap and forms a separate individual granule or pastille on the upper surface of said planar member, or (ii) freely drops from the lower portion of the orifice and falls upon the upper surface of said planar member and forms an individual granule or pastille on the upper surface of said planar member, said traveling member being cooled by a mist or spray of cooling liquid contacting the lower surface of said planar member.

2. A process as in claim 1 wherein said traveling planar member is an endless belt impervious to cooling liquid.

3. A process as in claim 2 wherein said endless belt is a steel belt.

4. A process as in claim 1 wherein at least a portion of said plug of molten unadulterated brominated anionic styrenic polymer bridges said gap and forms a separate individual granule or pastille on the upper surface of said planar member.

5. A process as in claim 1 wherein at least a portion of said plug of molten unadulterated brominated anionic styrenic polymer freely drops from the lower portion of the orifice and falls upon the upper surface of said planar member and forms an individual granule or pastille on the upper surface of said planar member.

6. A process as in claim 1 wherein (a) at least a portion of said plug of molten unadulterated brominated anionic styrenic polymer bridges said gap and forms a separate individual granule or pastille on the upper surface of said planar member; or wherein (b) at least a portion of said plug of molten unadulterated brominated anionic styrenic polymer freely drops from the lower portion of the orifice and falls upon the upper surface of said planar member and forms an individual granule or pastille on the upper surface of said planar member; (a) and (b) occurring in an alternating or random manner.

7. A process as in claim 1 wherein said mist or spray of cooling liquid is a mist or spray of cooling water.

8. A process as in claim 7 wherein said mist or spray of cooling water is applied to the lower surface of said planar member below the region in which the separate individual granule or pastille is formed on the upper surface of said planar member.

9. Solidified granules or pastilles of unadulterated brominated anionic styrenic polymer having (i) a bromine content of at least about 50 wt %, (ii) an average particle length of at least 0.2 inch, and an average crush strength of at least 40 pounds per inch.

10. Solidified granules or pastilles as in claim 9 wherein said bromine content is at least about 60 wt %.

11. Solidified granules or pastilles as in claim 9 wherein said bromine content is in the range of about 67 to about 71 wt %.

12. Solidified granules or pastilles as in claim 9 wherein said average crush strength is at least 45 pounds per inch.

13. Solidified granules or pastilles as in claim 10 wherein said average crush strength is at least 45 pounds per inch.

14. Solidified granules or pastilles as in claim 11 wherein said average crush strength is at least 45 pounds per inch.

15. Solidified granules or pastilles as in claim 9 wherein said solidified granules or pastilles have a generally dome shape configuration.
